(19) United States
(12) Patent Application Publication
(10) Pub. No.: US 2024/0251427 A1
(43) Pub. Date: Jul. 25, 2024

(54) METHOD OF STATUS INFORMATION INDICATION FOR NETWORK NODES

(71) Applicant: ZTE CORPORATION, Shenzhen (CN)

(72) Inventors: Ziyang LI, Shenzhen (CN); Nan ZHANG, Shenzhen (CN); Wei CAO, Shenzhen (CN); Hanqing XU, Shenzhen (CN); Linxi HU, Shenzhen (CN)

(73) Assignee: ZTE CORPORATION, Shenzhen (CN)

(21) Appl. No.: 18/424,980

(22) Filed: Jan. 29, 2024

Related U.S. Application Data
(63) Continuation of application No. PCT/CN22/74387, filed on Jan. 27, 2022.

(51) Int. Cl. H04W 72/25; H04B 7/06; H04B 7/155

(52) U.S. Cl. CPC H04W 72/25; H04B 7/06964; H04B 7/15557

(57) ABSTRACT

Method, device and computer program product for wireless communication are provided. A method includes: performing, by a network node, a sensing operation to acquire a sensing result of the sensing operation; and transmitting, by the network node to a wireless communication node, the sensing result or information of one or more actions corresponding to the sensing result.

### CROSS-REFERENCE TO RELATED PATENT APPLICATIONS

This application is a Continuation of PCT Application No. PCT/CN2022/074387, filed Jan. 27, 2022, incorporated herein by reference in its entirety.

### TECHNICAL FIELD

This document is directed generally to wireless communications, and in particular to 5^{th} generation (5G) communications.

### BACKGROUND

Coverage is a fundamental aspect of cellular network deployments. Mobile operators rely on different types of network nodes to offer blanket coverage in their deployments.

### SUMMARY

As a result, new types of network nodes have been considered to increase mobile operators' flexibility for their network deployments. For example, Integrated Access and Backhaul (IAB) was introduced in Rel-16 and enhanced in Rel-17 as a new type of network node not requiring a wired backhaul. Another type of network node is the RF repeater which simply amplify-and-forward any signal that they receive. RF repeaters have seen a wide range of deployments in 2G, 3G and 4G to supplement the coverage provided by regular full-stack cells.

This document relates to methods of status information indication for network nodes, devices thereof and systems thereof.

One aspect of the present disclosure relates to a wireless communication method. In an embodiment, the wireless communication method includes: receiving, by a network node, status indication information comprising at least one of: an on/off status or a power control status; and determining, by the network node, a status of the network node according to the status indication information.

Another aspect of the present disclosure relates to a wireless communication method. In an embodiment, the wireless communication method includes: transmitting, by a wireless communication node to a network node, status indication information to determine a status of the network node according to the status indication information.

Another aspect of the present disclosure relates to a wireless communication node. In an embodiment, the wireless communication node includes a communication unit and a processor. The processor is configured to: receive, by the communication unit, status indication information comprising at least one of: an on/off status or a power control status; and determine a status of the network node according to the status indication information.

Another aspect of the present disclosure relates to a wireless communication node. In an embodiment, the wireless communication node includes a communication unit and a processor. The processor is configured to: transmit, by the communication unit to a network node, status indication information to determine a status of the network node according to the status indication information.

Various embodiments may preferably implement the following features:

Preferably or in some embodiments, the on/off status comprises at least one of: an on/off status of the network node; an on/off status of a group of network nodes; an on/off status of one or more antenna ports of the network node; an on/off status of one or more beam indexes of the network node; an on/off status of one or more serving sectors of the network node; or an on/off status of one or more components of the network node.

Preferably or in some embodiments, the on/off status further comprises at least one of: a 1-bit on/off status, a duration of the on/off status, or a periodicity of the on/off status.

Preferably or in some embodiments, the on/off status further comprises the on/off status of at least one of following links: a first communication link from a wireless communication node to the network node; a second communication link from the network node to the wireless communication node; a first forwarding link from the wireless communication node to the network node; a second forwarding link from the network node to the wireless communication node; a third forwarding link from the network node to a user equipment, UE; or a fourth forwarding link from the user equipment to the network node.

Preferably or in some embodiments, the power control status comprises at least one of the following power control parameters: a target power, a path loss compensation factor, a closed loop power control parameter, a power ramping step, an amplified gain, a maximum amplified gain, or a max transmission power.

Preferably or in some embodiments, the power control status is applied for at least one of following links: a first communication link from a wireless communication node to the network node; a second communication link from the network node to the wireless communication node; a first forwarding link from the wireless communication node to the network node; a second forwarding link from the network node to the wireless communication node; a third forwarding link from the network node to a user equipment, UE; or a fourth forwarding link from the user equipment to the network node.

Preferably or in some embodiments, determining the on/off status comprises at least one of: in response to the network node being configured with a power saving mode, PSM or a Discontinuous Reception, DRX, mode, determining one or more forwarding links to be off; in response to the network node being in a radio link failure, RLF, state or a beam failure recovery, BFR, state, determining one or more forwarding links to be off; or in response to one or more forwarding links being configured with a PSM mode or a DRX mode, determining the one or more forwarding links to be on or off according to a configuration of the PSM mode or the DRX mode.

Preferably or in some embodiments, the status indication information is determined based on at least one of an explicit indication, an implicit indication, or an Operations, Administration and Maintenance, OAM, configuration.

Preferably or in some embodiments, the explicit indication is indicated through at least one of: a Radio Resource Control, RRC, message; Downlink Control Information, DCI; a Medium Access Control Control Element, MAC CE; or system information.

Preferably or in some embodiments, the system information or the RRC message is configured to indicate at least one of: a periodic on/off status, power levels, or pre-configured parameters for the implicit indication.

Preferably or in some embodiments, one of the power levels is activated by the DCI, the MAC CE or the implicit indication.

Preferably or in some embodiments, a first type of the DCI comprises the status indication information corresponding to a first link of the network node, and a second type of the DCI comprises the status indication information corresponding to a second link of the network node.

Preferably or in some embodiments, a DCI field comprises the status indication information.

Preferably or in some embodiments, the DCI field includes at least one of following: a Transmit Power Control, TPC, field; a Modulation Coding Scheme, MCS, field; a redundancy version, RV, field; a New data indicator, NDI, field; a spare bit in the DCI field; or a reserved bit in the DCI field.

Preferably or in some embodiments, the status indication information comprises at least one of an on/off status, values of power control parameters, or an activation of a set of power levels.

Preferably or in some embodiments, a MAC CE comprises the status indication information, and the status indication information comprises at least one of: an on/off status, power levels of power control parameters, or an activation of a power level from a set of pre-indicated power levels.

Preferably or in some embodiments, the implicit indication corresponds to at least one of: a reference signal sequence, a port of the reference signal port, a code division multiplexing, CDM, group index, a low peak-to-average power ratio, PAPR, sequence, a frequency band, a Modulation Coding Scheme, MCS, or a status of the network node.

Preferably or in some embodiments, at least one of an on/off status or a power level of the status indication information is indicated by at least one of a sequence generation value or a sequence index of the reference signal sequence.

Preferably or in some embodiments, at least one of an on/off status or a power level of the status indication information is indicated by at least one of: a port index of the reference signal sequence or the CDM group index.

Preferably or in some embodiments, the reference signal sequence comprises a Demodulation Reference Signal, DMRS, a Phase Tracking Reference Signal, PTRS, or a Channel Status Information Reference Signal, CSI-RS.

Preferably or in some embodiments, wherein at least one of an on/off status or a power level of the status indication information is indicated by a cyclic shift of the low PAPR sequence.

Preferably or in some embodiments, at least one of an on/off status or a power level of the status indication information is indicated by the frequency band of a downlink signal.

Preferably or in some embodiments, at least one of an on/off status or a power level of the status indication information is indicated by a comparison result between a pre-configured MCS threshold, and an indicated MCS.

Preferably or in some embodiments, at least one of an on/off status or a power level of the status indication information corresponds to a forwarding status of the network node.

Preferably or in some embodiments, the Operations, Administration and Maintenance, OAM, configuration is configured to indicate at least one of: a periodic on/off status, power levels, or pre-configured parameters for the implicit indication.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a network according to an embodiment of the present disclosure.

FIG. 2 shows a schematic diagram of transmission links between BS to SN and SN to UE according to an embodiment of the present disclosure.

FIG. 3 shows a tree diagram according to embodiments of the present disclosure.

FIG. 4 shows a schematic diagram of different cyclic shifts for 1 RB sequence according to an embodiment of the present disclosure.

FIG. 5 shows an example of a schematic diagram of a wireless terminal according to an embodiment of the present disclosure.

FIG. 6 shows an example of a schematic diagram of a wireless network node according to an embodiment of the present disclosure.

FIGS. 7 to 8 show flowcharts of methods according to embodiments of the present disclosure.

### DETAILED DESCRIPTION

In some embodiments, a network-controlled repeater can be introduced as an enhancement over conventional RF repeaters with the capability to receive and process side control information from the network. Side control information could allow a network-controlled repeater to perform its amplify-and-forward operation in a more efficient manner. Potential benefits could include mitigation of unnecessary noise amplification, transmissions and receptions with better spatial directivity, and simplified network integration.

Network-controlled repeater can be regarded as a steppingstone of Re-configurable intelligent surface (RIS), a RIS node can adjust the phase and amplitude of received signal to improve the coverage.

In this disclosure, such kind of network nodes, including and not limited to network-controlled repeater, smart repeater, Re-configuration intelligent surface (RIS), Integrated Access and Backhaul (IAB), are denoted as a smart node (SN) for simplicity. SN is a kind of network node to assist a base station (BS) to improve coverage and given that SNs are not aware of other SNs, a user equipment (UE) may suffer from interference from other SNs, especially for cell edge UEs.

In an embodiment, for mitigating unexpected interference, a method of status information indication is provided so that the network can explicitly or implicitly indicate some of the status information of SN, e.g., on/off amplify-and-forward operation, power control and so on.

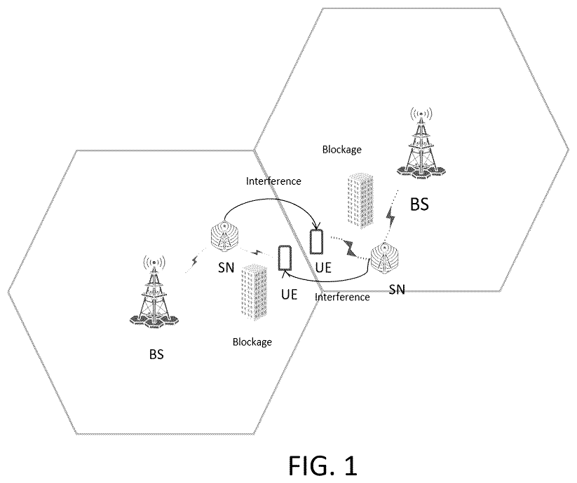

FIG. 1 shows a schematic diagram of a network (architecture) according to an embodiment of the present disclosure. As illustrated in FIG. 1, the BSs can serve the UEs respectively in their cells via the SNs when there are blockages between the BSs and the UEs. However, in some cases, the signals from an SN may interfere the communications in an adjacent cell.

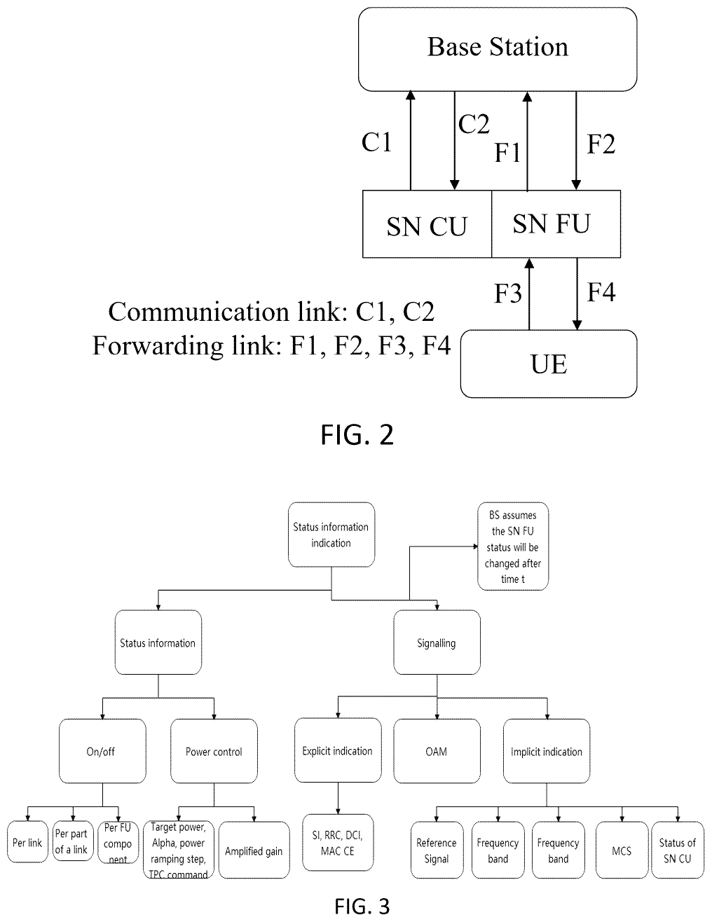

FIG. 2 shows a schematic diagram of transmission links between BS to SN and SN to UE according to an embodiment of the present disclosure. The SN consists of 2 functional parts: one is the communication unit (CU) and the other is the forwarding unit (FU). The SN CU acts like a UE to receive and decode side control information from the BS. The SN CU may be a mobile terminal (MT), part of a UE, a third-party IoT device and so on. And the SN FU carries out intelligent amplify-and-forward operation using the side control information received by the SN CU. SN FU may be a radio unit (RU), a RIS and so on.

The transmission links between BS to SN and SN to UE as shown in FIG. 2 are defined as follows:
C1: Communication link from SN CU to BS;
C2: Communication link from BS to SN CU;
F1: Forwarding link from SN FU to BS;
F2: Forwarding link from BS to SN FU;
F3: Forwarding link from UE to SN FU; and
F4: Forwarding link from SN FU to UE.

Communication link means the signal from one side will be detected and decoded by the other side, so that the information transmitting in the communication link can be utilized to control the status of forwarding links.

Forwarding link means the signal from BS or UE is unknown to SN FU, SN FU will simply amplify and forward signals without decoding them. F1+F3 is the complete UL forwarding link from UE to BS, in which F1 is the SN FU UL forwarding link; F2+F4 is the complete DL forwarding link from BS to UE, in which F4 is the SN FU DL forwarding link.

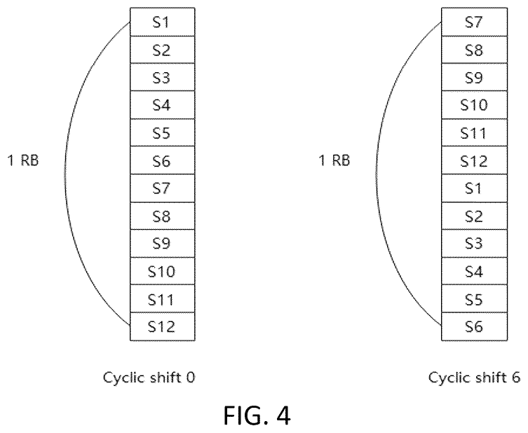

FIG. 3 shows a tree diagram according to embodiments of the present disclosure.

In an embodiment, the BS transmits status information indication to the SN, and the status of the SN is changed according to the indication (left arm of the tree diagram of FIG. 3).

In an embodiment, status information includes on/off status and/or power control status of SN FU.

In an embodiment, the on/off status comprises at least one of: a 1-bit on/off status (e.g., “on” or “off”), a duration of the on/off status, or a periodicity of the on/off status.

In an embodiment, the status information includes the on/off status: the status “on” means the SN will amplify and forward received signals corresponding to the on/off status. The on/off operation can have different granularities, including at least one of the following cases:

### 1. Per SN:

In an embodiment, the BS indicates the on/off signaling to turn on/off the SN (e.g., the forwarding functionality). In an embodiment, the BS indicates the on/off signaling to turn on/off the SN (e.g., the forwarding functionality). In an embodiment, the BS indicates the on/off signaling to turn on/off a group of SNs.

2. Per Link or Link Combination (this May be Up to the Definition of Link):

In an embodiment, the on/off status corresponds to UL forwarding link(s), F1 or F1+F3. For example, when the UL forwarding link F1 is “off”, the SN FU will only disable the transmitting operation, but it may receive and process the received signals; when the UL forwarding links F1+F3 are “off”, the SN FU will disable both the transmitting and receiving operation.

In an embodiment, the on/off status corresponds to DL forwarding link(s) F4 or F2+F4. For example, when the DL forwarding link F4 is “off”, the SN FU will only disable the transmitting operation, but it may receive and process the received signals; when the DL forwarding links F2+F4 are “off”, the SN FU will disable both the transmitting and receiving operation.

In an embodiment, the on/off status corresponds to UL+DL forwarding link F1+F4 or F1+F2+F3+F4. For example, when the forwarding links F1+F4 are “off”, the SN FU will only disable the transmitting operation, but it may receive and process the received signals; when the DL forwarding links F1+F2+F3+F4 are “off”, the SN FU will disable both the transmitting and receiving operation.

### 3. Per Part of a Link:

In an embodiment, the on/off status corresponds to antenna port. For example, SN FU may have several antenna ports, and status information may indicate the status of at least one of these antenna ports.

In an embodiment, the on/off status corresponds to beam index. For example, SN FU may have several beams, and status information may indicate the status of at least one of beams, including disabling part of beam (such functionality can also be achieved according to the reconfiguration of beam/TCI information).

In an embodiment, the on/off status corresponds to sectors, For example, similar to gNB sectors, SN may serve UEs from different sectors, and each sector covers a region of serving area.

### 4. Per FU Component:

This is related to the circuit or hardware design of the SN FU, status information may indicate the status of at least one of these FU component. e.g., if the SN is an RIS, the FU component may be RIS component, RIS panel, amplitude, phase and so on.

In an embodiment, wherein the status information includes the power control status: the granularity of the on/off status can also be applied to the power control status. It should also be noted that the indication of the power control status may be on link or link combination basis (e.g., F1 or F4 or F1+F4).

In an embodiment, the power control mechanism of the SN forwarding link may be the same or different compared to a regular UE, and the power control status of SN may be related to the following several power control parameters:
Target power, i.e., the expected power at the receiver side;
Alpha, i.e., the path loss compensation factor;
TPC command, i.e., the closed loop power control parameter;
Power ramping step, i.e., the added power compared with previous one;
Amplified gain or maximum amplified gain, i.e., the amplified power that may be added on input power to determine the output power; or
Max transmission power, i.e., the maximum output power of SN.

In an embodiment, the power control status may include at least one of: a set of power levels or an activation of one of the power levels. In an embodiment, the power level could be a set of values for the power control parameters.

Next, various embodiments related to the signaling arm in FIG. 3 are disclosed (right arm of the tree diagram of FIG. 3).

In general, as one example, after BS transmits the status information indication, BS assumes the SN (e.g., FU) status is changed after time t (i.e., processing time to implement such status change), t can be in slot level, symbol level, frame level, sub-frame level, absolute time level (e.g., μs, ms, s). The determination of t is mainly up to SN's capability.

In an embodiment, the status information indication can be through at least one of explicit indication, implicit indication or OAM configuration. The status information indication may also include joint signaling of one or more of these methods, e.g., on/off status can be configured periodically by static or semi static signaling (System information, RRC, OAM), it can also be dynamically indicated through DCI, MAC CE or implicit indication.

Explicit indication: In an embodiment, the explicit indication includes at least one of:

### 1. System Information

In an embodiment, through system information, a periodic on/off status can be indicated to SN, and SN will periodically apply the on/off status.

In an embodiment, through system information, different power levels can be indicated to SN, and the actual power level will be activated through DCI, MAC CE or implicit indication from a set of power levels.

In an embodiment, through system information, some pre-configured values used for implicit indication can be indicated to SN, e.g., sequence for correlation operation, MCS threshold.

### 2. RRC

In an embodiment, through RRC message, a periodic on/off status can be indicated to SN, and SN will periodically apply the on/off status.

In an embodiment, through RRC message, different power levels can be indicated to SN, and the actual power level will be activated through DCI, MAC CE or implicit indication from a set of power levels.

In an embodiment, through RRC message, some pre-configured values used for implicit indication can be indicated to SN, e.g., sequence for correlation operation, MCS threshold.

### 3. DCI

In an embodiment, a new DCI format may be defined as DCI x_0 and DCI x_1 including the status information of UL forwarding link and DL forwarding link, respectively.

In an embodiment, a new DCI bit field may be defined including status information.

In an embodiment, an existing DCI bit field can be re-interpret to indicate status information, including at least one of TPC field, MCS field, RV field, NDI field, spare bit or reserved bit, e.g. NDI (new data indicator) field, in which “1” may indicate “on” and “0” may indicate “off”); TPC command field can be used to indicate the power control status; MCS value can be used to compare with a pre-configured value to indicate on/off status; RV field, value 0 to indicate off, other values indicate on.

In the embodiments described above, the status information may include the on/off status, and the value of power control parameter or the activation of a set of power levels.

### 4. MAC CE

In an embodiment, a new MAC CE may be defined, e.g., SN status information MAC CE, including on/off status and/or power levels of power control parameters.

In an embodiment, a new MAC CE may be defined, e.g., SN status information MAC CE, including on/off status and/or activation of a power level from a set of pre-indicated power levels.

Implicit indication: In an embodiment, the implicit indication includes at least one of:

1. RS Sequence, Such as n_{SCID} and Sequence Index of the RS Sequence can be Used to Implicitly Indicate Status Information.

In an embodiment, the RS can be DMRS, PTRS, CSI-RS.

Some examples are provided below.
Example 1: n_{SCID} selected from {0,1} is used to indicate status on/off, where n_{SCID} is used to generate a DMRS sequence.
Example 2: sequence indexes 0 and 1 are used to indicate status on/off.
Example 3: n_{SCID} selected from {0,1} is used to indicate power level 1 and power level 2, wherein n_{SCID} is used to generate a RS sequence.
Example 4: sequence indexes 0, 1, . . . N are used to indicate power level 1 to N.

### 2. RS Port, RS Port Index and CDM Group Index can be Used to Implicitly Indicate Status Information:

In an embodiment, the RS can be DMRS, PTRS, CSI-RS.

Some examples are provided below.
Example 1: DMRS port indices can be divided into odd numbers and even numbers to indicate status on/off.
Example 2: DMRS port indices can be divided into odd numbers and even numbers to indicate power level 1 and level 2.
Example 3: CDM group 0 and 1 can be used to indicate status on/off.
Example 4: CDM group 0 and 1 can be used to indicate power level 1 and level 2.

### 3. Low PAPR Sequence, Such as Different Cyclic Shifts of the Low PAPR Sequence can be Used to Implicitly Indicate Status Information:

In an embodiment, the low PAPR sequence can be a low PAPR sequence type 1 or a low PAPR sequence type 2.

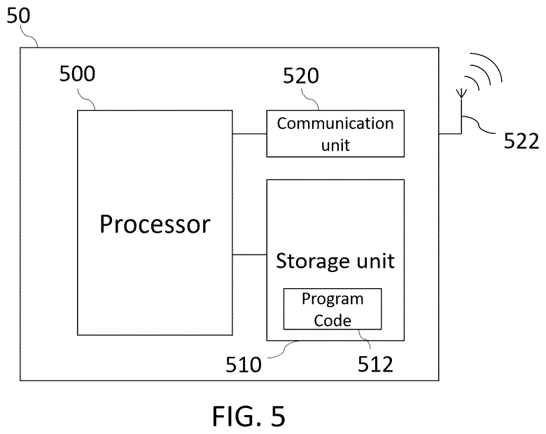

Some examples are provided below.
Example 1: as shown in FIG. 4, cyclic shift equaling to 0 and 6 indicate status on/off.
Example 2: as shown in FIG. 4, cyclic shift equaling to 0 and 6 indicate power level 1 and power level 2, wherein power level could be a set of values for power control parameters.

### 4. Frequency Band

Some examples are provided below.
Example 1: DL signal from gNB to SN CU can be configured in 2 bands, Band 1 and Band 2 can indicate the status on/off.
Example 2: DL signal from gNB to SN CU can be configured in 2 bands, Band 1 and Band 2 can indicate power level 1 and level 2.

### 5. MCS

Some examples are provided below.
Example 1: An MCS threshold can be pre-configured to SN, then the comparison between the indicated MCS; and pre-configured MCSₚ, such as MCSᵢ>MCSₚ and MCSᵢ<=MCSₚ, can be used to indicate status on/off.
Example 2: An MCS threshold can be pre-configured to SN, then the comparison between the indicated MCSᵢ and pre-configured MCSₚ, MCSᵢ>MCSₚ and MCSᵢ<=MCSₚ, can be used to indicate power level 1 and level 2.

### 6. Status of SN CU

Some examples are provided below.
Example 1: SN CU is configured with DRX (Discontinuous reception), within DRX active time, the status of SN FU will be on, otherwise, the status will be off.
Example 2: SN CU is configured with DRX (Discontinuous reception), within DRX active time, the power level of SN FU will be level 1, otherwise, the power level will be level 2.

In an embodiment, a new status for SN (e.g., forwarding-on/off status) can be defined to indicate status information:

In this status, the SN will monitor certain signaling which will be related to the on/off status for forwarding, e.g., DCI, MAC CE or dedicated sequence as described above. When SN is not within forwarding-on/off status, the SN will keep the on/off status determined in previous forwarding-on/off status, or keep default on/off status, e.g., always on.

In an embodiment, a new status for SN (e.g., forwarding-power control status) can be defined to indicate status information.

In this status, the SN will monitor certain signaling which will be related to the power control signaling for forwarding, e.g., DCI, MAC CE or dedicated sequence as described above. When SN is not within forwarding-power control status, the SN will keep the power level determined in previous forwarding-power control status, or keep default power level (max transmission power).
Example 3: When the SN CU is configured with PSM (Power saving mode), within PSM, the status of SN FU will be off, otherwise, the status will be on.
Example 4: When the SN CU is configured with RLF (radio link failure) or BFR (beam failure recovery), the status of SN FU will be off, otherwise, the status will be on.
Example 5: When the SN FU is configured with PSM or DRX, the corresponding forwarding link will be off according to the configuration.

In an embodiment, OAM configuration can also be used to indicate the status information.

In an embodiment, through OAM configuration, a periodic on/off status can be indicated to SN, and SN will periodically apply on/off status.

In an embodiment, through OAM configuration, different power levels can be indicated to SN, and the actual power level will be activated through DCI, MAC CE or implicit indication from a set of power levels.

In an embodiment, through OAM configuration, some pre-configured values used for implicit indication can be indicated to SN, e.g., sequence for correlation operation, MCS threshold.

In an embodiment, BS transmits (sends) status information indication to SN (smart node), and the status of SN is determined according to the indication.

In an embodiment, the status indication includes on/off status and power control status, wherein the on/off status may be SN level (per SN or SN group), link level (UL or DL or UL+DL), or part of link level (e.g., antenna port, beam index), or per FU component.

In an embodiment, the power control status may include at least one of target power, alpha, power ramping step, TPC command, amplified gain, max amplified gain, or max transmission power for forwarding link.

In an embodiment, the status indication may be transmitted from BS to SN, wherein the signaling method includes explicit indication through at least one of RRC, DCI, MAC CE, or system information; and/or implicit indication through at least one of RS sequence, RS port, low PAPR sequence, CSI-RS port, frequency band, MCS, or status of SN CU; and/or OAM configuration.

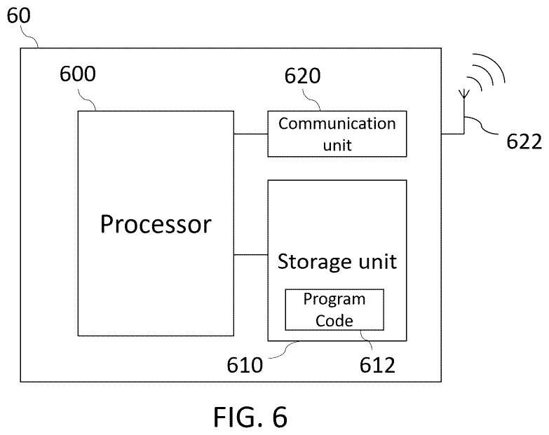

FIG. 5 relates to a schematic diagram of a wireless terminal 50 according to an embodiment of the present disclosure. The wireless terminal 50 may be a user equipment (UE), a mobile phone, a laptop, a tablet computer, an electronic book or a portable computer system and is not limited herein. The wireless terminal 50 may include a processor 500 such as a microprocessor or Application Specific Integrated Circuit (ASIC), a storage unit 510 and a communication unit 520. The storage unit 510 may be any data storage device that stores a program code 512, which is accessed and executed by the processor 500. Embodiments of the storage unit 512 include but are not limited to a subscriber identity module (SIM), read-only memory (ROM), flash memory, random-access memory (RAM), hard-disk, and optical data storage device. The communication unit 520 may a transceiver and is used to transmit and receive signals (e.g., messages or packets) according to processing results of the processor 500. In an embodiment, the communication unit 520 transmits and receives the signals via at least one antenna 522 shown in FIG. 5.

In an embodiment, the storage unit 510 and the program code 512 may be omitted and the processor 500 may include a storage unit with stored program code.

The processor 500 may implement any one of the steps in exemplified embodiments on the wireless terminal 50, e.g., by executing the program code 512.

The communication unit 520 may be a transceiver. The communication unit 520 may as an alternative or in addition be combining a transmitting unit and a receiving unit configured to transmit and to receive, respectively, signals to and from a wireless network node (e.g., a base station).

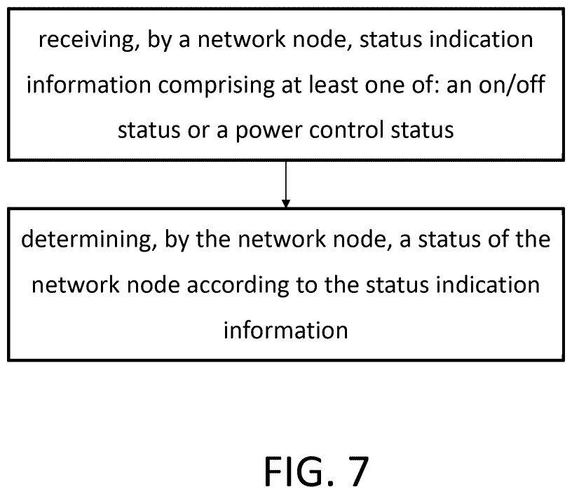

FIG. 6 relates to a schematic diagram of a wireless network node 60 according to an embodiment of the present disclosure. The wireless network node 60 may be a satellite, a base station (BS), a smart node, a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 60 may comprise (perform) at least one network function such as an access and mobility management function (AMF), a session management function (SMF), a user place function (UPF), a policy control function (PCF), an application function (AF), etc. The wireless network node 60 may include a processor 600 such as a microprocessor or ASIC, a storage unit 610 and a communication unit 620. The storage unit 610 may be any data storage device that stores a program code 612, which is accessed and executed by the processor 600. Examples of the storage unit 612 include but are not limited to a SIM, ROM, flash memory, RAM, hard-disk, and optical data storage device. The communication unit 620 may be a transceiver and is used to transmit and receive signals (e.g., messages or packets) according to processing results of the processor 600. In an example, the communication unit 620 transmits and receives the signals via at least one antenna 622 shown in FIG. 6.

In an embodiment, the storage unit 610 and the program code 612 may be omitted. The processor 600 may include a storage unit with stored program code.

The processor 600 may implement any steps described in exemplified embodiments on the wireless network node 60, e.g., via executing the program code 612.

The communication unit 620 may be a transceiver. The communication unit 620 may as an alternative or in addition be combining a transmitting unit and a receiving unit configured to transmit and to receive, respectively, signals to and from a wireless terminal (e.g., a user equipment or another wireless network node).

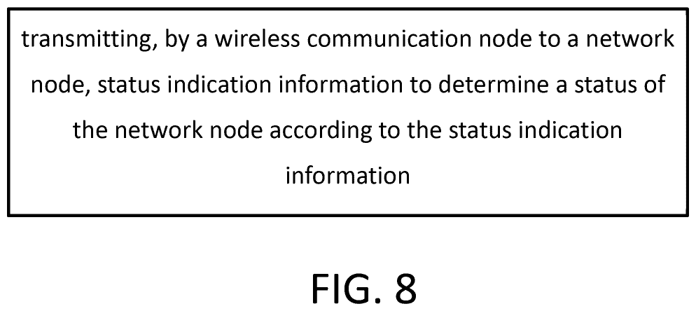

FIG. 7 shows a flowchart of a method according to an embodiment of the present disclosure. The method shown in FIG. 7 may be used in a network node (e.g., a smart node) and comprises: receiving, by a network node, status indication information comprising at least one of: an on/off status or a power control status; and determining, by the network node, a status of the network node according to the status indication information.

Details in this regard are disclosed in the embodiments above.

FIG. 8 shows a flowchart of a method according to an embodiment of the present disclosure. The method shown in FIG. 8 may be used in a wireless network node (e.g., a BS) and comprises: transmitting, by a wireless communication node to a network node, status indication information to determine a status of the network node according to the status indication information.

Details in this regard are disclosed in the embodiments above.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method implemented by Smart Node (SN) including: a SN Communication Unit (SN CU) for receiving and decoding side control information from a Base Station (BS) and a SN Forwarding Unit (SN FU) for carrying out amplify-and-forward operation using the side control information received by the SN CU, the method comprising:
in response to the SN CU being in a Radio Link Failure (RLF) state or a beam failure recovery, BFR, state, determining that a status of the SN FU is off.

2. The wireless communication method of claim 1, the method comprises: the off status indicates the SN FU to turn off the forwarding functionality.

3. The wireless communication method of claim 1, wherein the off status indicates the SN FU to disable both the transmitting and receiving operation.

4. The wireless communication method of claim 3, wherein the off status indicates the off status of forwarding links between SN FU and BS and forwarding links between SN FU and UE are off.

5. The wireless communication method of claim 1, wherein the SN is network-controlled repeater.

6. The wireless communication method of claim 1, the method comprises:
receiving, by the SN, status indication information, wherein the status indication information indicates an on status, the on status corresponds to beam index.

7. The wireless communication method of claim 6, wherein the status indication information indicates a duration of the on status.

8. The wireless communication method of claim 6, wherein the on status of the status indication information indicates the SN to amplify and forward received signals.

9. The wireless communication method of claim 1, wherein the SN FU is a Radio Unit (RU) or a Re-configurable Intelligent Surface (RIS).

10. The wireless communication method of claim 1, wherein the SN CU is a Mobile Terminal (MT), part of a User Equipment (UE) or a third-party Internet of Things (IoT) device.

11. A Smart Node (SN) including a processor and comprising:
a SN Communication Unit (SN CU) configured to receive and decode side control information from a Base Station (BS),
a SN Forwarding Unit (SN FU) configured to carry out amplify-and-forward operation using the side control information received by the SN CU,
wherein, in response to the SN CU being in a Radio Link Failure (RLF) state or a beam failure recovery (BFR) state, the processor is configured to determine that a status of the SN FU is off.

12. The SN of claim 11, wherein the off status indicates the SN FU to turn off the forwarding functionality.

13. The SN of claim 11, wherein the off status indicates the SN FU to disable both the transmitting and receiving operation.

14. The SN of claim 13, wherein the off status indicates the off status of forwarding links between SN FU and BS and forwarding links between SN FU and UE are off.

15. The SN of claim 11, wherein the SN is network-controlled repeater.

16. The SN of claim 11, the SN CU further configured to:
receive, by the SN, status indication information, wherein the status indication information indicates an on status, the on status corresponds to beam index.

17. The SN of claim 16, wherein the status indication information indicates a duration of the on status.

18. The SN of claim 16, wherein the on status of the status indication information indicates the SN to amplify and forward received signals.

19. The SN of claim 11, wherein the SN FU is a Radio Unit (RU) or a Re-configurable Intelligent Surface (RIS).

20. The SN of claim 11, wherein the SN CU is a Mobile Terminal (MT), part of a User Equipment (UE) or a third-party Internet of Things (IoT) device.
